(19) United States
(12) Patent Application Publication
(10) Pub. No.: US 2007/0280141 A1
(43) Pub. Date: Dec. 6, 2007

(54) Hardware implementation of loop initialization protocol

(75) Inventor: Kannan Sachidanandam, Dallas, TX (US)

Correspondence Address: Myers Bigel Sibley & Sajovec, P.A., P.O. Box 37428, Raleigh, NC, 27627, US

(73) Assignee: SEAGATE TECHNOLOGY, LLC

(21) Appl. No.: 11/788,611

(22) Filed: Apr. 20, 2007

Related U.S. Application Data
(60) Provisional application No. 60/746,096, filed on May 1, 2006.

(51) Int. Cl. H04L 12/28

(52) U.S. Cl. 370/254

(57) ABSTRACT

A device includes a loop port controlled by a loop initialization procedure in response to control flags. The device includes a programmable controller and a fibre channel loop port including a transmitter, a receiver, and a port control circuit. The port control circuit controls the loop initialization procedure in response to control flags set by the programmable controller. Methods of performing loop initialization in a loop port include initializing a loop initialization protocol (LIP) hardware state machine, controlling LIP operations with the LIP hardware state machine, determining if control of the loop initialization operations should be transferred to a programmable controller in response to a predetermined loop initialization event, and if so, transferring control of the loop initialization operations to the programmable controller.

### RELATED APPLICATION

This application claims the benefit of and priority to U.S. Provisional Patent Application No. 60/746,096 titled “Hardware Implementation of Fibre Channel Loop Initialization Protocol,” filed May 1, 2006, the disclosure of which is hereby incorporated herein by reference as if set forth in its entirety.

### BACKGROUND

The present invention relates to data communications systems and methods. In particular, the present invention relates to systems and methods for implementing a loop initialization protocol for a Fibre Channel Arbitrated Loop data communication system.

High speed data communication protocols are used to transfer large amounts of data at high speeds over a communications channel from a sending, or originating, terminal (sender) to a receiving terminal (receiver). The communications channel may include, for example, a switched or dedicated channel in a data communications network. Data communications networks may be classified by geographic scope, such as a local area network (LAN), which may be as small as a single room or as large as several buildings, or a wide area network (WAN), which may span hundreds of miles or more.

It may also be convenient to classify networks on a functional/logical basis. For example, a storage area network (SAN) is a network that provides access to high-speed storage devices. In many cases, a substantial portion of network traffic in an enterprise involves storing and/or retrieving large amounts of data from local or remote databases. A storage area network interconnects different kinds of data storage devices with associated data servers. A storage area network is usually located near the servers/users it serves, but may also include remote locations for physically secure archival storage, using wide area network protocols such as Asynchronous Transfer Mode (ATM) or Synchronous Optical Network (SONET).

High speed data communication protocols define an orderly process for setting up, using, and taking down (inactivating) a communications channel. Such protocols may be used to send data from one communications terminal to another over a wired and/or wireless communications channel. For example, high-speed data communications protocols may be used to send data from one communications terminal to another over a satellite and/or microwave communications link. High speed data communications protocols may be used to send data to/from a peripheral device, such as a mass storage device (e.g. a hard disk drive), a scanner, a camera, a printer, or the like, from/to a central processing unit of a computer. In that case, one of the communications terminals may include a host adapter (or host bus adapter), which is attached to both the central processing unit and the communications channel, and which mediates the use of the communications channel.

### SUMMARY

A device according to some embodiments includes a programmable controller and a fibre channel loop port including a transmitter, a receiver, and a port control circuit. The port control circuit is configured to control a loop initialization procedure of the loop port in response to control flags set by the programmable controller.

### BRIEF DESCRIPTION OF THE DRAWINGS

The accompanying drawings, which are incorporated in and constitute a part of this application, illustrate certain embodiment(s). In the drawings:

FIG. 1 is a block diagram illustrating a Fibre Channel Arbitrated Loop topology.

FIG. 2 is a block diagram illustrating some aspects of a data communications terminal including a Fibre Channel Arbitrated Loop (FC/AL) loop port according to some embodiments.

FIG. 3 is a block diagram illustrating some aspects of an FC/AL loop port according to some embodiments.

FIG. 4 is a flowchart illustrating loop initialization operations according to some embodiments.

FIGS. 5A and 5B are flowcharts illustrating loop initialization state machine operations according to some embodiments.

FIG. 6 is a flowchart illustrating loop initialization state machine operations according to some embodiments.

### DETAILED DESCRIPTION

Embodiments will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer program code embodied in the medium that can be executed by a computer. Any suitable computer readable medium may be utilized including hard disks, CD ROMs, optical storage devices, or magnetic storage devices.

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

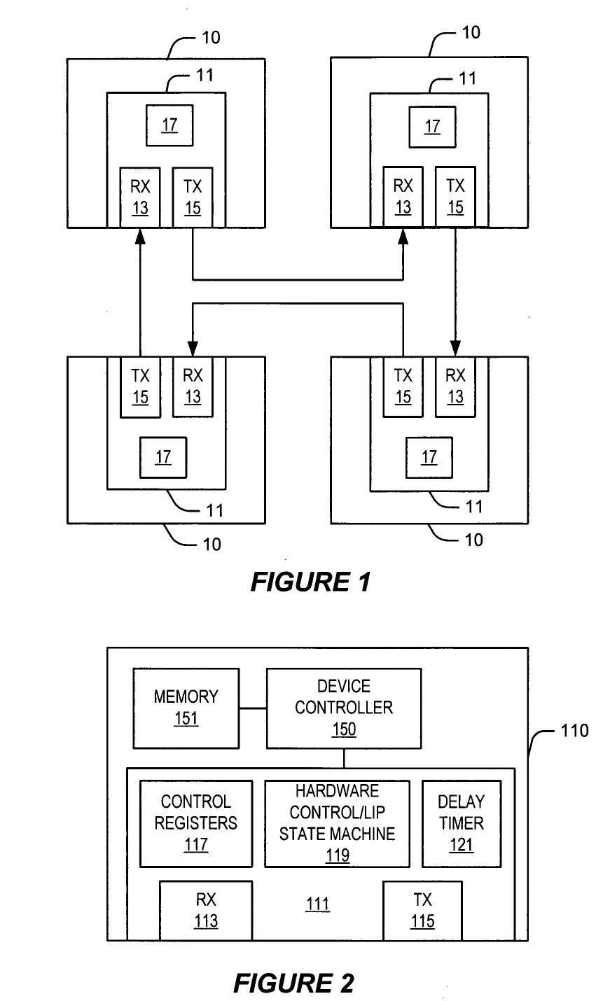

Fibre Channel Arbitrated Loop is a data communications protocol that is commonly used to provide high speed data communications between mass storage devices and central processing units. In a Fibre Channel Arbitrated Looped topology, devices are connected in a loop, as illustrated in FIG. 1. As shown in FIG. 1, each device 10 in the loop includes a port 11 (referred to as an L_port) that includes a receiver 13 and a transmitter 15. Each of the devices 10 further includes a port controller 17 that controls the operations of the port 11. The devices 10 may further include other elements, such as an application processor, a storage device, other input/output devices, memory, etc., that may use the port 11 to communicate with other devices 10 on the loop. The devices 10 are connected in a loop fashion such that data travels from port to port around the loop.

Before communications can occur on the loop (for example, at power-up and/or after loop resets), each port 11 on the loop may be assigned an address that is used to communicate with the device 10 to which the port 11 belongs. The address is an 8-bit address referred to as an Arbitrated Loop Physical Address (ALPA). Up to 127 devices may be connected in a loop. The process of initializing the loop is performed according to a Loop Initialization Protocol (LIP) that is defined according to the Fibre Channel protocol standard.

When an initialization event occurs, a port 11 begins sending LIP primitives, or transmission words, continuously until it detects a LIP primitive at its receiver 13. Upon detecting a LIP primitive, the port 11 enters an OPEN-INIT state. In the OPEN-INIT state, the port 11 sends Loop Initialization Select Master (LISM) data frames, which are used to select which port 11 on the loop will act as the Loop Initialization Master for the current initialization sequence. The Loop Initialization Master performs certain administrative functions during the initialization sequence.

Initially, the LISM data frames include three fields: D_ID (a 3-byte destination identifier), S_ID (a 3-byte source identifier), and Port Name (an 8-byte identifier). The values of these fields are determined by firmware in the device 10. The fields are used to determine priority in selecting the Loop Master.

At each port 11, received LISM frames are compared with the LISM frames currently being sent out by the port 11. If the received LISM frames are algebraically lower than the LISM frames currently being sent out, then the received LISM frames are transmitted on the loop by the port 11. Otherwise, the received LISM frames are ignored by the device and not re-transmitted.

In comparing LISM frames, an LISM frame with a smaller D_ID value is algebraically lower than an LISM frame with a larger D_ID value. If the D_ID values are equal, then the LISM frame with the smaller S_ID value is algebraically lower. If both the S_ID and D_ID values are equal, then the LISM frame with the smaller Port Name is algebraically lower.

If a received LISM frame is equal to the original LISM frame generated by the port 11, then it is assumed that the port 11 has lowest-valued (i.e. highest priority) LISM frame. In response, the originating device assumes the role of Loop Initialization Master. The Loop Initialization Master assumes control of the loop by transmitting an ARB primitive around the loop. As each port 11 receives and processes the ARB primitive, it is informed that a Loop Initialization Master has been selected. Once the ARB primitive has completed its circuit of the loop, the Loop Initialization Master begins an iterative procedure for determining ALPAs for all the active ports 11 on the loop.

After a Loop Initialization Master has been designated, the ports 11 on the loop are allowed to select an ALPA. ALPA selection is performed by sequentially transmitting four predefined initialization frames listed in Table 1 around the loop. The frames are originated by the Loop Initialization Master.

Each of the four initialization frames listed in Table 1 (LIFA, LIPA, LIHA and LISA) includes an ALPA bitmap including 127 bits, each of which corresponds to an allowable ALPA. As the initialization frames proceed around the loop, each port 11 may select (and set) a single bit in the bitmap and repeat the frame back on the loop.

TABLE 1
Loop Initialization Frames

| | | Order |
|---|---|---|
| Frame | Purpose | Transmitted |
| LIFA | Used to designate addresses | 1 |
| (Loop Initialization | assigned by the Fabric before the | |
| Fabric Assigned) | initialization process | |
| LIPA | Used to acquire previously | 2 |
| (Loop Initialization | assigned addresses that are still | |
| Previously Acquired) | valid | |
| LIHA | Used to acquire a hard-assigned | 3 |
| (Loop Initialization | address, if no address was assigned | |
| Hard Assigned) | in the LIFA and LIPA steps | |
| LISA | Used to assign a free address if no | 4 |
| (Loop Initialization | address was assigned in the LIFA, | |
| Soft Assigned) | LIPA, or LIHA steps | |

Thus, for example, if a port 11 had a valid ALPA before the loop initialization began, it may attempt to reclaim the previously acquired address by checking the LIPA frame to see if the bit associated with that address is available. If the address is available (i.e. the bit is not yet set), the port 11 may claim the address by setting the bit and repeating the LIPA frame to the next port 11 in the loop. If the address is not available (i.e. it has already been claimed), the port 11 will wait for the LIHA or LISA frame to claim an available address.

Once the LISA frame has come back around the loop to the Loop Initialization Master, all ports 11 should have selected an ALPA. If there are more than 127 devices on the loop, then some devices may not have an address assigned and may not be able to communicate on the loop.

Two additional frames may be sent by the Loop Initialization Master if all ports on the loop support them. The first is the Loop Initialization Report Position (LIRP) frame. As the LIRP frame traverses the loop, each port 11 adds its ALPA to the end of a list in the frame. When the LIRP frame has returned to the Loop Initialization Master, it contains a record of the relative positions of all ports 11 on the loop. Finally, the Loop Initialization Master may transmit a Loop Initialization Loop Position (LILP) frame, which contains the ALPA address and relative position of each port 11 on the loop.

Whether or not the LIRP and/or LILP frames are transmitted, the initialization process concludes when the Loop Initialization Master transmits a CLS primitive around the loop. Upon receiving the CLS primitive, each of the ports 11 enters a monitoring state in which the port 11 waits to receive a frame on its input port or to be notified by its host device 10 that it has data to be transmitted on the loop.

Control of the loop initialization processes is typically implemented in software since the LIP standard is loosely enforced. It may be desirable for a device to be capable of handling implementation errors of other host bus adapters on the loop. Furthermore, a port 11 may encounter various idiosyncrasies, such as variations in the spacing between different events, variations in the frequency of sending repeated frames, and/or other implementation variations. It may be difficult to anticipate all problems and/or variations that may arise, since the other devices on the loop may be unknown and/or may behave in an unpredictable fashion.

Some embodiments provide a flexible hardware-based approach to performing loop initialization in a communications environment, such as a Fibre Channel environment. There may be a number of benefits to implementing the loop initialization process (“LIP process”) in hardware, as opposed to firmware or software. For example, it may be desirable or required that certain operations during the LIP process be performed within a given time duration. This may be difficult to accomplish when the same firmware processor that attends to other functions within a device 10 also attends to the LIP process, since the firmware may have other high priority actions to take at the time a random LIP event occurs.

Although it may be possible to provide a dedicated processor to control the LIP process, this may be expensive and wasteful, given that the LIP process may be performed on an intermittent basis, and may or may not experience variations, protocol violations, or unexpected occurrences.

A hardware-based approach to controlling the LIP process according to some embodiments may address certain objectives. Namely, the approach may provide for the creation of large LIP frames (such as the LILP and LIRP frames, which are 168 bytes long each). An approach according to some embodiments may also provide for the generation and/or processing of various types of LIP frames, and for managing the steps of the LIP process.

A LISM frame is 48 bytes. The LIFA, LIPA, LIHA and LISA frames are 56 bytes long each. The LILP and LIRP frames are 168 bytes long each. A hardware implementation of LIP according to some embodiments may be capable of generating some or all of these frames, and may be capable of parsing and modifying some or all of them. Furthermore, in the Loop Initialization Master mode, some embodiments may generate certain initialization frames, such as LIPA, LIHA and LISA frames, by modifying previous initialization frames. Accordingly, some embodiments employ a store and modify approach, in which logic is used to read the frame buffers and modify the frames as appropriate. Accordingly, in some embodiments, separate memory space may not be used for constructing the initialization frames.

A system according to some embodiments may provide a fully automated hardware implementation of the Loop Initialization Protocol, in which the LIP process may be controlled by one or more hardware-implemented state machines operating independently according to control flags set by firmware. The risk of dealing with unpredictable (nonstandard or erroneous) behavior of other devices on the loop may be mitigated by providing hooks that allow the hardware-based state machines to request firmware intervention to deal with exceptional issues. Depending on which flag bits are set by the firmware at startup, upon the occurrence of a specified exception, the state machine implementing the LIP process may stop execution and interrupt the firmware to request assistance. The firmware may then take control of the LIP process and take appropriate action. In some embodiments, after handling the exception, the firmware may then restart the state machine, to thereby hand control of the LIP process back to the hardware component. In other embodiments, the firmware may complete the LIP process such that the hardware component may not regain control of the LIP process until another LIP event is initiated.

Even with interrupts enabled, the hardware state machine may free the firmware processor from a substantial portion of the initialization tasks. At one extreme, the hardware state machine may attempt to perform all of the LIP tasks. For example, in a fully automated mode, the state machine may be fully capable of auto generating even the largest of loop initialization frames using state variables. At another extreme, the firmware may be configured to handle all of the initialization tasks. Some embodiments may be configured to operate at either, both, or neither of these extremes.

According to some embodiments, a timer may be employed in the state machine(s) to manage timing of and/or between LIP events, such as the sending of initialization frames and/or primitives. The timer may be provided with a number of programmable values and separate enables for various events to allow the state machine(s) to be set up to account for and/or mimic the characteristics of other devices on the loop during loop initialization. For example, the timer may be used to implement one or more operational characteristics to accommodate the idiosyncrasies of other devices that may be deployed on the loop.

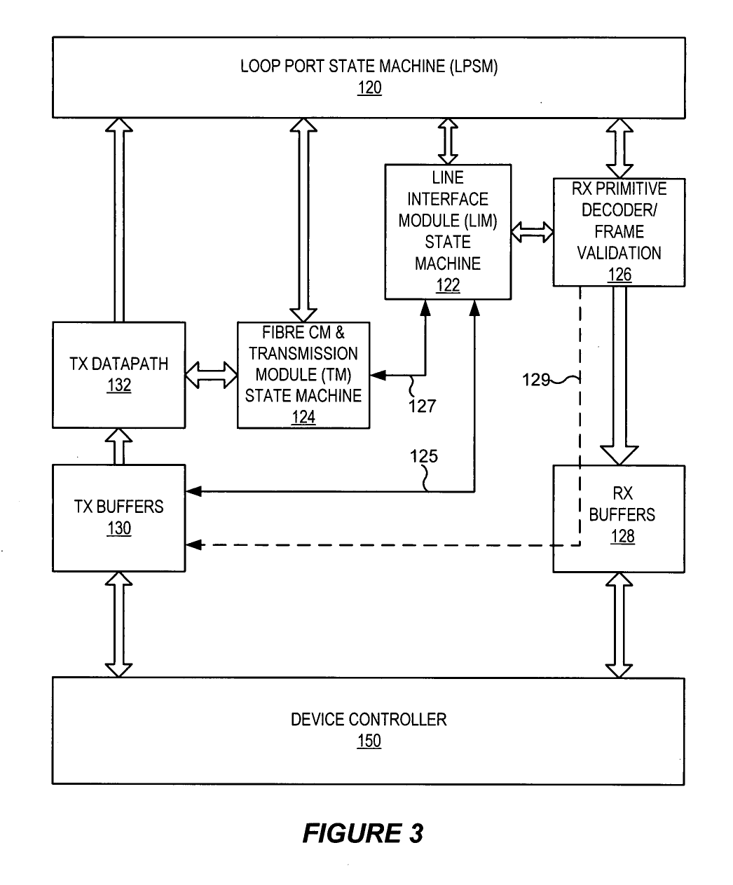

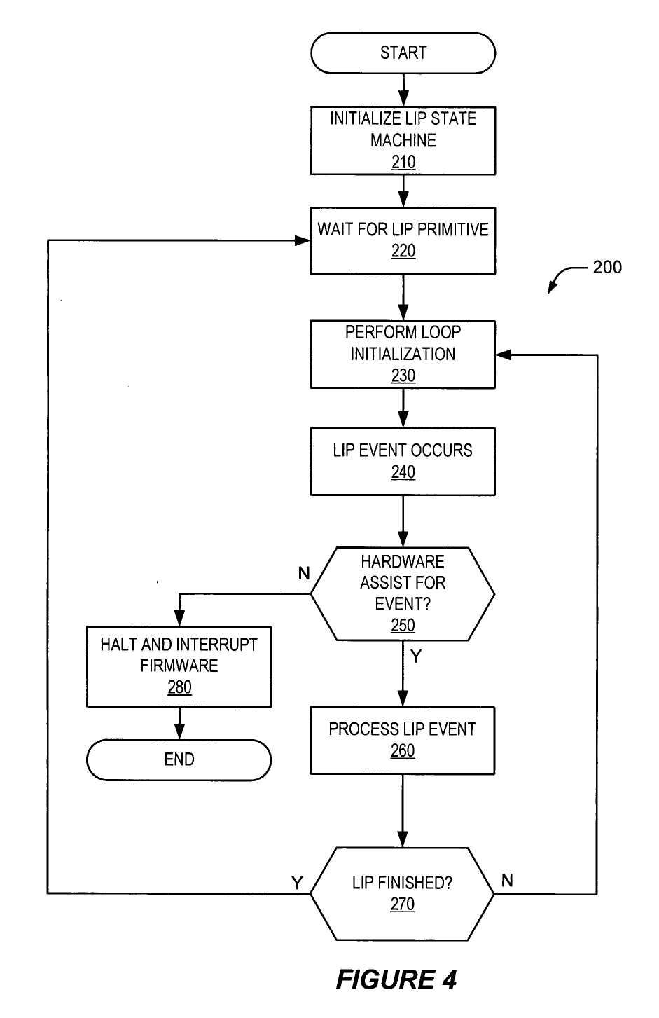

FIGS. 2 and 3 are schematic block diagrams that illustrate some functional aspects of a device 110 including a Fibre Channel Arbitrated Loop port 111 according to some embodiments. As shown in FIG. 2, a device 110 may include a device controller 150 coupled to a memory 151, which may include a dynamic memory such as a RAM, a static memory such as a ROM and/or a SRAM or flash memory. The device 110 further includes a port 111 that includes a receiver 113 and a transmitter 115. The port 111 further includes a hardware control circuit 119 that is configured to implement a LIP state machine that controls some operations of the port 111, including LIP processes. The port 111 further includes a set of control registers 117 that may contain state information, configuration information and/or other information used in the operation of the port 111. The control registers 117 may be accessed by the hardware control circuit/LIP state machine 119, and may be accessed and modified by the device controller 150.

Referring to FIGS. 2 and 3, the port 111 includes a Loop Port State Machine (LPSM) 120 that communicates with the receiver 113 and transmitter 115. The LPSM 120 receives data to be transmitted via a transmit (TX) data path 132, and passes data received on the port 111 to a receive (RX) primitive decoder/frame validation block 126. The operation of the transmit data path 132 is controlled by a transmission module (TM) state machine 124, while the operation of the receive decoder 126 is controlled by a line interface module (LIM) state machine 122.

Received frames are stored in the receive (RX) buffers 128, while frames to be transmitted are stored in the transmit (TX) buffers 130.

The LPSM 120, the TM 124 and the LIM 122 may together operate as a hardware-implemented LIP state machine for controlling the LIP process within the device 110. In some embodiments, the LIP process may be implemented by only one of these state machines, such as the LIM 122, which may be configured to modify frames stored in the transmit (TX) buffers 130, as indicated by the arrow 125. The LIM 122 may also be able to control/direct the operation of the TM state machine 124, as indicated by the arrow 127. In either case, the LIP state machine may be implemented fully in hardware.

As further illustrated by arrow 129 of FIG. 3, data frames come in through the RX data path. In the LIP mode, the incoming frames may be loaded directly into the TX buffers 130 from the RX buffers 128. Thus, the TX buffers 130 may be flushed during the LIP process. However, flushing the TX buffers 130 may not be problematic, since no data may be transmitted during the LIP process. In addition, when the LIP process is initiated, the data stored in the TX buffers 130 may be stored in a separate memory, such as the memory 151, and the flushed frames may be regenerated from the memory 151 upon completion of the LIP process.

Received frames are parsed for useful data, such as the 127-bit address bitmap, by the RX primitive decode/frame validation block 126, and are validated on the way in the RX data path. In some embodiments, frames may be modified on the way out in the TX data path 132. For example, frames may be modified to claim an ALPA in the address bitmap and/or to generate certain initialization frames, such as LIPA, LIHA and/or LISA frames.

Initialization frames that are originated by the port 111 when the port 111 is in Loop Initialization Master mode, such as the LIFA, LIPA, LIHA and/or LISA frames, may be generated by hardware, since the frame header is fixed and the data fields are either state variables, static information, or may be obtained from an already-received initialization frame. These data fields may not be stored, but rather may be generated by logic within the LIP state machine. For example a LIPA frame may be generated by modifying an existing LIFA frame, a LIHA frame may be generated by modifying an existing LIPA frame, and so on.

Referring to FIG. 2, the control registers 117 contain programmable bits that may specify, among other things, the handling of error conditions at each step of the LIP process. In particular, a specified error condition or exception may be handled either by the hardware state machine or by firmware/software control, depending on the state of an associated bit in the control registers 117. Additional bits in the control registers may reflect device configuration and/or mode page options, such as whether or not the device 110 will participate in a given LIP step. For example, the device 110 may be configured, via bit settings in the control registers 117, not to claim an ALPA in the LIFA, LIHA, LIPA or LISA steps, or to bypass LIP altogether and claim an address separately, e.g., in systems that support ALWLI (Allow Login Without Loop Initialization). The ability to act as Loop Initialization Master is also programmable via a control register bit setting. For example, in some cases a user may specify that the device 110 should not try to act as the Loop Initialization Master.

Some of the programmable bits in the control registers 117 may instruct the RX primitive decoder/frame validation block 126 on the receive path to ignore certain types of errors in LIP frames, as well as to save or discard frames having errors.

In the initialization process, the Transmission Module 124 can claim an ALPA by setting an appropriate bit in the address bitmap as the initialization frames are being transmitted, or may send them unaltered.

When a programmable bit in the control registers 117 is set to indicate that firmware assistance is requested to handle a specified condition, upon the occurrence of the specified condition, the LIP state machine 119 may raise an interrupt with a reason code that identifies the condition or reason for the interrupt. The programmable device controller 150 may then take over for the LIP state machine 119, and continue the initialization process until the programmable device controller 150 is ready for the LIP state machine 119 to resume control of the initialization process. The programmable device controller 150 may then set initial conditions for the LIP state machine 119 according to the current state of the initialization process by setting and/or clearing appropriate bits in the control registers 117, and restart the LIP state machine 119.

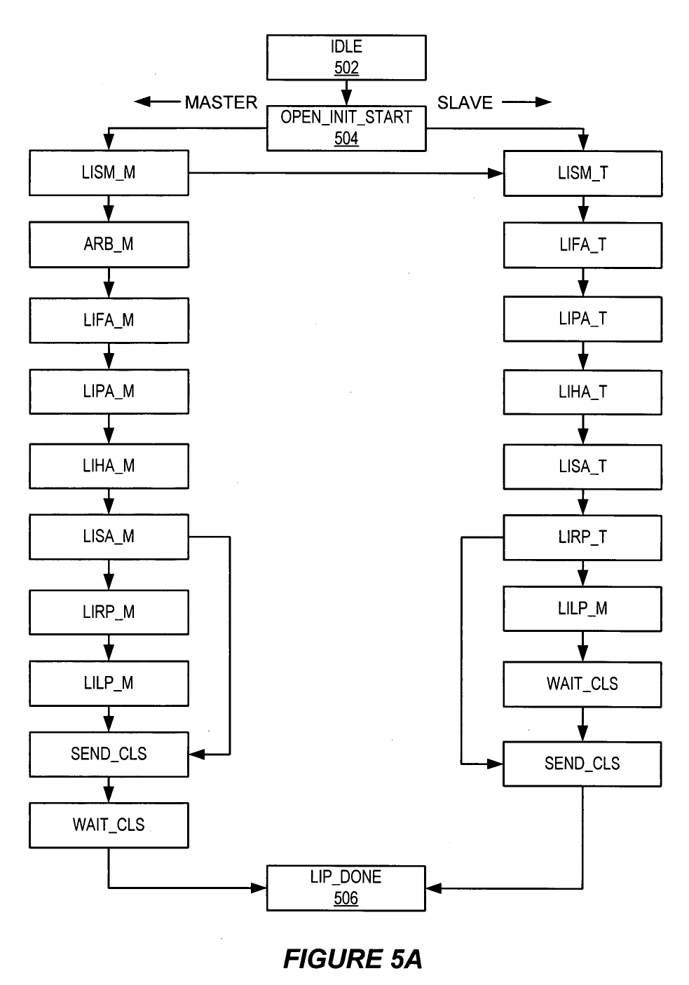

For example, FIG. 4 illustrates some operations 200 that may be performed by a LIP state machine 119 according to some embodiments in connection with a LIP process. First, the LIP state machine 119 may be initialized, for example by the device controller 150 loading appropriate control flags in the control registers 117 (Block 210). The LIP state machine 119 then monitors the messages arriving at the port 111 until a LIP primitive is received (Block 220), at which time the LIP state machine 119 begins to execute loop initialization procedures (Block 230).

When a specified LIP event occurs (Block 240), such as the receipt of a particular type of LIP frame, the LIP state machine 119 determines if hardware assist is enabled for handling the event (Block 250). If so, the LIP state machine processes the event (Block 260). Otherwise, the LIP state machine may halt execution and interrupt the firmware processor (Block 280) to request that the event be handled in firmware. The firmware processor may then continue to handle the LIP process, or may restart the LIP state machine 119 and return control of the LIP processing to the LIP state machine 119.

After the LIP state machine 119 has handed an event, a check is made in Block 270 to determine if the LIP operations are complete (e.g., to see if a CLS primitive has been received). If so, the LIP state machine 119 returns to Block 220 and waits for the next LIP primitive to arrive. Otherwise, the LIP state machine 119 continues the process of loop initialization (Block 230).

The control registers 117 may include a 32-bit LIP state machine control register containing LIP state machine control flags and/or control values, as shown in Table 1.

TABLE 1
LIP State Machine Control Register

| Bit | Name | Description |
|---|---|---|
| 0 | disable_LIFA | Do not participate in LIFA |
| 1 | disable_LIPA | Do not participate in LIPA |
| 2 | disable_LIHA | Do not participate in LIHA |
| 3 | disable_LISA | Do not participate in LISA |
| 4 | restartonLPTOV | Restart without firmware intervention on LPTOV |
| | | (timeout) |
| 5 | norestartLIP | Do not restart without firmware intervention on LIP |
| | | received |
| 6 | restartonbadlipfr | Restart without firmware intervention on bad LIP |
| | | frame in any step |
| 7 | restartonbadcls | Restart without firmware intervention on an |
| | | unexpected CLS in any LIP step |
| 8 | loopmastersupported | Loop Master mode is supported |
| 9 | LISMFrame_assist1 | Make discard/forward decisions on received LIP frame |
| 10 | LISMFrame_assist2 | Hardware assist in originating LISM frame |
| 11 | LIFAFrame_assist1 | Hardware assist in processing LIFA frame |
| 12 | LIHAFrame_assist1 | Hardware assist in processing LIHA frame |
| 13 | LILPFrame_assist1 | Hardware assist in processing LILP frame |
| 14 | LIPAFrame_assist1 | Hardware assist in processing LIPA frame |
| 15 | LIRP_M_assist1 | Hardware assist in originating LIRP frame |
| 16 | LIRP_T_assist1 | Hardware assist in processing LIRP frame |
| 17 | LISAFrame_assist1 | Hardware assist in processing LISA frame |
| 18-22 | LPTOV_timeout_limit | 5-bit number that LPTOV (LIP timeout value) timer |
| | | counts down from |
| 23 | lirp_notsupported | The port does not support the LILP/LIRP steps of LIP |
| 24 | rxnotdiscard_lipfr | Prevents discarding of bad LIP frame |
| 25 | one_BBcredit | Port is supporting a BBcredit of 1 |
| 26 | two_BBcredit | Port is supporting a BBcredit of 2 |
| 27 | UsingFairness | Port is supporting fairness in arbitration |
| 28 | Reserved | Reserved |
| 29 | Reserved | Reserved |
| 30 | Reserved | Reserved |
| 31 | Reserved | Reserved |

Each of the bits in the LIP state machine control register shown in Table 1 may be set or reset by the device controller 150, and may be read by the LIP state machine 119. Accordingly, the control register shown in Table 1 may indicate whether or not the LIP state machine 119 will participate in various LIP steps, such as LIFA, LIPA, LIHA or LISA, whether the LIP state machine 119 will restart automatically on the occurrence of certain events, such as a timeout, the receipt of a bad LIP frame or CLS primitive, whether the port 110 will act as a Loop Initialization Master, whether originating and/or processing various types of initialization frames should be performed in hardware by the LIP state machine 119, and/or whether or not certain optional LIP frames, such as LILP and LIRP are supported. In addition, the control register shown in Table 1 may specify a LIP timeout value, and may further indicate what the LIP state machine 119 should do with bad LIP frames. The control register may further specify whether the port 110 supports a buffer credit (BB_credit) value of 1 or 2, and may specify whether or not the port 110 should support Fairness in Arbitration, which is an optional aspect of the Fibre Channel specification.

As shown in FIG. 2, the port 110 may further include a programmable delay timer 121. Although the programmable delay timer 121 is shown in FIG. 2 as a separate element from the LIP state machine 119, it will be appreciated that the programmable timer 121 may be implemented as part of the LIP state machine 119.

Using the programmable delay timer 121, a programmable delay can be introduced before or between the various LIP steps, for example, before sending a particular LIP initialization frame. The programmable timer 121 may cause the LIP state machine 119 to wait in a given state until the timer 121 expires. During this period, the LPSM 120 may transmit IDLE primitives. The programmable delay may permit a system according to embodiments of the invention to accommodate other types of devices in the loop, which may expect loop initialization activities to be performed with different delay times. For example, Table 2 illustrates various delay times associated loop initialization tasks performed by systems manufactured by various manufacturers.

TABLE 2
Loop Initialization Timing of Various Systems

| | | Idles | | | Idles | Idles | Idles | Idles | Idles | Idles |
|---|---|---|---|---|---|---|---|---|---|---|
| | | sent | | Idles | between | between | between | between | between | between |
| | Idles | after | ARB | sent | LIFA | LIPA | LIHA | LISA | LIRP | LILP |
| | between | Last | F0s | before | and | and | and | and | and | and |
| System | LISMs | LISM | sent | LIFA | LIPA | LIHA | LISA | LIRP | LILP | CLS |
| Hardware | 6 | 0 | 64 | 3 | 1819 | 907 | 707 | 997 | >4095 | 3595 |
| System 1 | 32 | 461 | 59 | 1866 | 2150 | 1214 | 1633 | 1611 | >4095 | 3566 |
| System 2 | 32 | 258 | 56 | 1502 | 1604 | 1528 | 1005 | 1657 | >4095 | 3584 |
| System 3 | >4095 | 1229 | 57 | 1459 | 2150 | 2338 | 1658 | 2745 | >4095 | 3678 |
| System 4 | >4095 | 1359 | 368 | 452 | 2460 | 1695 | 1550 | 2397 | >4095 | 3792 |
| System 5 | >4095 | 2979 | 1619 | 1312 | >4095 | 3915 | >4095 | >4095 | >4095 | >4095 |
| System 6 | 796 | 943 | 133 | 155 | 1619 | 1122 | 977 | 1333 | >4095 | 3503 |
| System 7 | 6 | 32 | 56 | 360 | 1552 | 1225 | 1006 | 1877 | >4095 | 3592 |

In Table 2, the system labeled “Hardware” is a system configured according to embodiments of the invention to perform loop initialization using a hardware automated state machine. As can be seen in Table 2, the number of Idle primitives, which is indicative of delay at a particular step, that may be sent at a particular step may vary widely from system to system. It may be further seen from Table 2 that a hardware-based system may be capable of sending various loop initialization frames much more quickly than other systems. Thus, it may be desirable in some cases to delay the sending of certain frames so that a loop initialization frame may not be sent before a downstream port is ready for it.

In some embodiments, the timer values listed in Table 3 below may be provided.

TABLE 3
Timer values

| Name | # of Bits | Description |
|---|---|---|
| LISMDLY_TMOUT_limit | 8 | Inter LISM delay count using |
| | | 1 μs pulse or |
| | | 160 MHz clock |
| LIFPHDLY_TMOUT_limit | 8 | Inter-LIP frame delay count |
| ARBDLY_TMOUT_limit | 8 | Delay before sending |
| | | ARB(F0) after last LISM |

An additional 16-bit timer control register may be provided in the control registers 117 to control how the LIP state machine 119 uses the delay timer values. For example, the 16-bit timer control register may include the bit fields listed in Table 4.

TABLE 4
Delay Timer Control Flags

| Bit | Name | Description |
|---|---|---|
| 0 | dly_LISM | Introduces a delay based on LISMDLY_TMOUT_limit |
| | | between LISM frames in Loop Master mode. |
| 1 | faster_LISM_DLY | Selects the 160 MHz clock for timing the inter-LISM delay |
| 2 | dly_ARB_ORIG | Introduces a delay based on |
| | | LIFPHDLY_TMOUT_limit between the last LISM frames |
| | | and Loop Master mode and sending or ARB. |
| 3 | dly_LIFA_ORIG | Introduces a delay based on |
| | | LIFPHDLY_TMOUT_limit between ARB received |
| | | and sending LIFA |
| 4 | dly_LIFA | Introduces a delay based on |
| | | LIFPHDLY_TMOUT_limit between receiving and sending |
| | | LIFA |
| 5 | dly_LIPA | Introduces a delay based on |
| | | LIFPHDLY_TMOUT_limit between receiving and sending |
| | | LIPA |
| 6 | dly_LIHA | Introduces a delay based on |
| | | LIFPHDLY_TMOUT_limit between receiving and sending |
| | | LIHA |
| 7 | dly_LISA | Introduces a delay based on |
| | | LIFPHDLY_TMOUT_limit between receiving and sending |
| | | LISA |
| 8 | dly_LIRP | Introduces a delay based on |
| | | LIFPHDLY_TMOUT_limit between receiving LISA |
| | | and sending LIRP when operating in Loop Master |
| | | mode |
| 9 | dly_LILP | Introduces a delay based on |
| | | LIFPHDLY_TMOUT_limit between receiving LIRP |
| | | and sending LILP |
| 10 | dly_CLS | Introduces a delay based on |
| | | LIFPHDLY_TMOUT_limit between receiving |
| | | LISA/LILP and sending CLS |
| 11 | dly_LIRP_ORIG | Introduces a delay between receiving LISA and |
| | | sending LIRP in Loop Master mode |
| 12 | Reserved | |
| 13 | Reserved | |
| 14 | Reserved | |
| 15 | Reserved | |

Referring again to FIG. 3, the RX primitive decoder/frame validation block 126 notifies the line interface module (LIM) state machine 122, which as noted above may act as the LIP state machine 119, of primitives received at the port 110. The LIM state machine 122 may also request the LPSM 120 to send various primitives on the loop. The LIM state machine 122 may control the sending of frames through the transmission module state machine 124. In the Loop Initialization Master mode, frames originate in the TM state machine 124. In the general case, frames are received and qualified by the RX primitive decoder/frame validation block 126 and stored in the TX buffers 130. The received initialization frames can be modified as they are retransmitted by the TM state machine 124.

When the port 110 is in Loop Initialization Master mode, the following additional steps may be taken if hardware assist is turned on for the individual steps:

In the LIHA step, the incoming LIPA frame header may be modified by the RX primitive decoder/frame validation block 126 to be a LIHA frame before the frame is written to the TX buffers 130.

In the LISA step, the incoming LIHA frame header may be modified by the RX primitive decoder/frame validation block 126 to be a LISA frame before being written to the TX buffers 130.

In the LILP step, the incoming LIRP frame header may be modified by the RX primitive decoder/frame validation block 126 to be a LILP frame before being written to the TX buffers 130.

The foregoing actions may be easily accomplished, since they may be performed by simply changing a known byte in the header of the incoming initialization frame as the data flows through the RX primitive decoder/frame validation block 126.

Checking the 16 byte ALPA bitmap in the LIFA/LIPA/LIHA initialization frames may also be done in the RX primitive decoder/frame validation block 126 when it loads a hard-assigned ALPA register in the LIHA stage or the acquired address register in the LISA stage, using a seven bit encoded ALPA stored by the device controller 150 in an ALPA register in the control registers 117. The ALPA may be claimed in any one of these steps by OR-ing the appropriate bit in the TM state machine 124 as the initialization frames are being transmitted.

Hard assigned address (LIHA) processing by the LIP state machine 119 may be performed as follows. The LIP state machine 119 may obtain the 16 byte ALPA bitmap from an incoming LIPA frame. If hardware assist is not turned on for the LIHA stage, a firmware interrupt is raised, and LIHA processing is performed, for example, by the device controller 150. If hardware assist is turned on for the LIHA stage and a valid ALPA is not stored in the ALPA register or the ALPA is already taken, then the received frame may be retransmitted by signaling the TM state machine 124 to send the current frame. If a valid ALPA is present in the ALPA register and the ALPA is not already taken, the LM state machine 122 may instruct the TM state machine 124 to apply the appropriate mask to the frame to set the appropriate bit in the ALPA bitmap to reserve the desired ALPA, and to retransmit the frame with the ALPA reserved.

Accordingly, the control registers 117 may also include a HA_ALPA bitmap register that may be used by the RX primitive decoder/frame validation block 126 to determine if the address is available. The previous ALPA bitmap may be used to do the search in the LIFA/LIPA stages.

If an improperly formatted frame is received or the LPTOV timer expires, the LIP state machine 119 may interrupt the device controller 150 to restart the LIP process.

Frames that are originated by the port 110 when the port 110 is in Loop Initialization Master mode can be easily generated by hardware, since the header is fixed and the data fields are either state variables, static or can be obtained from received initialization frames. The information used to build the generated frames need not be stored in memory or registers, but rather can be generated by logic in the LIP state machine 119.

In addition to the registers defined in the FC-AL-2 specification, some embodiments may define three 7-bit registers that may result in considerable savings in logic used to implement the LIP control function in hardware.

In addition, two tables may be provided to facilitate the address conversions that may be performed in the various LIP steps. A first table is provided that translates addresses from the 127 bit address bitmap to an 8-bit ALPA (in the LISA step). Another table may be provided to translate from the 8-bit ALPA to the 127 bit address bitmap to check if an address is available in a particular step.

In addition, reading a hard assigned address from the 7-bit pins of the device to an 8-bit ALPA may also use a 7 to 127 bit conversion to be able to look up the table. The additional registers provided in the control registers 117 are shown in Table 5.

TABLE 5
Control Registers

| Register Name | # of bits | Description |
|---|---|---|
| HA_ALPA | 8 | Hard Assigned ALPA |
| HA_BitMap | 7 | Hard Assigned Bit Map |
| Hard Assigned Valid | 1 | |
| HA_ALPA | 8 | Acquired ALPA |
| HA_BitMap | 7 | Acquired Bit Map |
| Acquired ALPA Valid | 1 | |
| PORT_ALPA | 8 | PORT ALPA |
| PORT_BitMap | 7 | PORT Bit Map |
| Port ALPA Valid | 1 | |
| FLOGI | 1 | Fabric Login Done |

It may be possible to avoid having the hardware referenced 127 X 8 lookup tables by compromising on the LISA step. If an address has to be acquired in the LISA step (i.e. no address was acquired in the LIFA, LIPA or LIHA steps), the device controller 150 may scan the available address bitmap in the LISA frame and load the Acquired Address Bit Map (7-bit) and the Acquired Address ALPA (8 bits) registers. Similarly, at start up, the device controller 150 may load the hard assigned bit map value into the HA_BitMap register and look up the ALPA associated with the hard assigned bit map and load it into the HA_ALPA register.

The control registers may further include previously assigned bitmap and previously assigned ALPA registers. The fabric assigned address may share the previously assigned address with an additional bit register indicating if fabric login has been performed. The bitmaps are used to check if an address is available and to claim an address if needed in each step. The ALPA is used in the LIRP step and to load the Port ALPA register that defines the port address.

The use of bitmap registers may permit the use of a 5-bit decode to a 32-bit bitmap. The remaining two bits of the bitmap register may be used to select one of four 32-bit double words that constitute the address map. This may be performed instead of performing an 8-bit ALPA to 127 bit decode. There may be a considerable savings in decode logic by this split, which is made possible because of the 7-bit bitmap representation.

This arrangement may make acquiring an address in the LISA step a firmware-driven process. However, if an address has already been acquired by the LISA step, or if the port 110 does not wish to participate in the LISA step, the hardware may automatically forward the LISA frame. This compromise may be acceptable, since certain devices, such as hard drives, may not be permitted to acquire a soft address. Accordingly, the typical case may be accelerated with a minimal hardware cost.

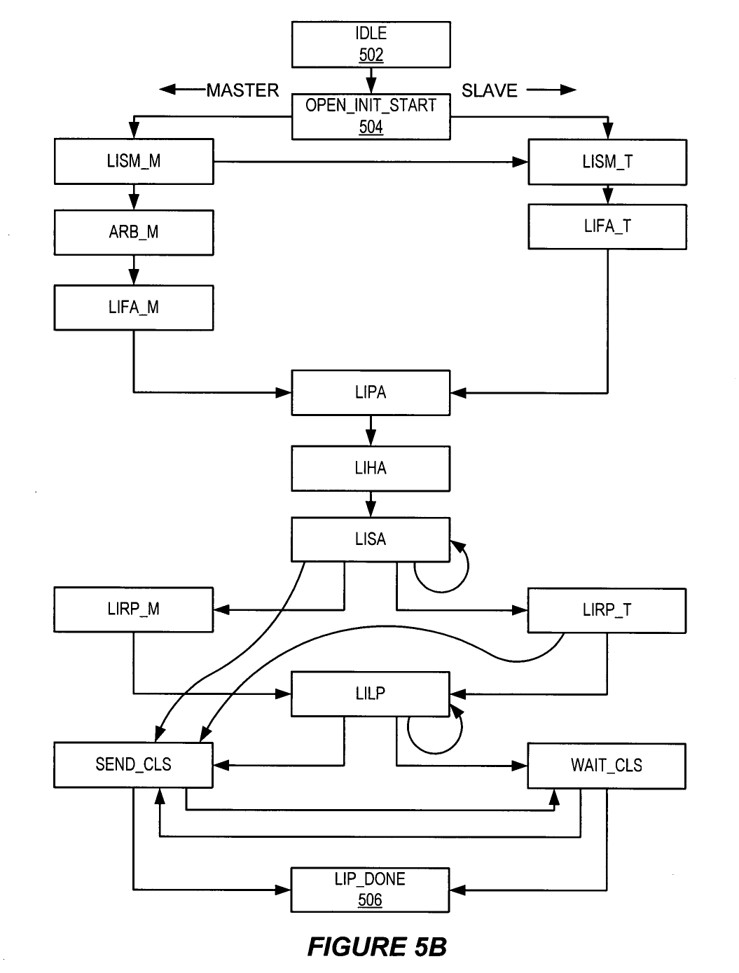

FIGS. 5A and 5B are flowcharts illustrating loop initialization state machine operations according to some embodiments. In some embodiments, the LIP state machine 119 may have different states depending on whether the state machine is acting in a Loop Initialization Master mode or not. For example, as illustrated in FIG. 5A, after entering an OPEN-INIT state (Block 504) from the IDLE state (Block 502), the states of the LIP state machine 119 may follow a first path (MASTER) if the LIP state machine 119 is configured to act as a Loop Initialization Master, and a second path (SLAVE) if the if the LIP state machine 119 is configured (or requested) to act as a slave (non-master) in the LIP process. In FIG. 5A, the states in the MASTER path are designated with a “_M” suffix, e.g., LISM_M, ARB_M, etc., while the states in the SLAVE path are designated with a “_T” suffix, e.g., LISM_T, LIFA_T, etc. As illustrated in FIG. 5A, the MASTER and SLAVE paths diverge after the LIP state machine enters the OPEN-INIT state, and do not converge again until the LIP process is complete at the LIP_DONE state (Block 506).

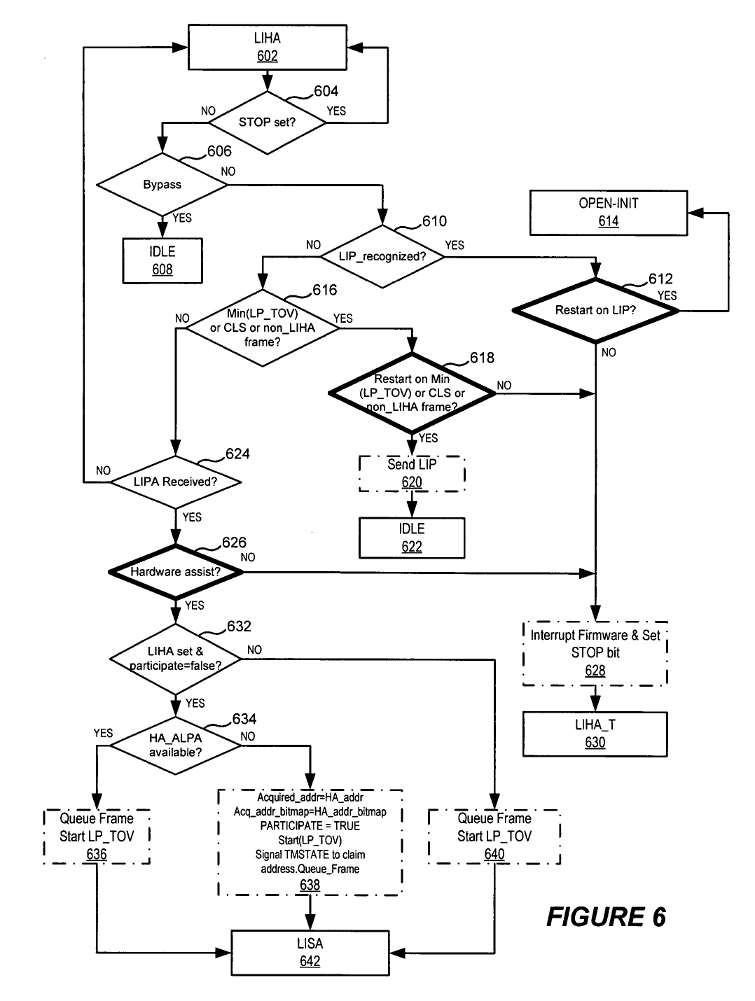

In some embodiments, some of the states of the LIP state machine 119 may be shared. That is, some of the states may be used in both the MASTER mode and the SLAVE mode, as illustrated in FIG. 6B. As shown therein, the LIPA, LIHA, LISA and LILP states may be shared, which may reduce the complexity and/or size of the LIP state machine 119. The SEND_CLS and WAIT_CLS states may also be shared. It will be appreciated that in a shared state such as the LISA state, the LIP state machine may keep track of whether it is in a MASTER or SLAVE mode so that the proper state (e.g. LIRP_M or LIRP_T will be entered at the conclusion of the shared state.

FIG. 6 is a flowchart illustrating loop initialization state machine operations in the LIHA (Loop Initialization Hardware Assigned) state according to some embodiments. In the flowchart of FIG. 6, a rectangular block with a solid line indicates a state of the LIP state machine 119, while a rectangular block with a dotted line indicates an action taken by the LIP state machine 19. A diamond with a thin line indicates a decision taken by the LIP state machine 119, while a diamond with a bold line indicates a decision taken by the LIP state machine 119 that is programmable using hardware bits.

Referring to FIG. 6, operations begin with the LIP state machine 119 in the LIHA mode (Block 602). Upon receipt of a LIP frame, the LIP state machine 119 checks to see if the STOP bit is set (Block 604). If so, the LIP state machine 119 remains in the LIHA mode and waits for another LIP frame. Otherwise, the LIP state machine checks to see if a BYPASS flag is on (Block 606). If so, the LIP state machine 119 enters the IDLE mode (Block 608). Otherwise, the LIP state machine 119 checks to see if the received frame is a LIP primitive (Block 610). If the received frame is a LIP primitive, then the LIP state machine checks to see if the Restart_on_LIP bit is set (Block 612), and if so the LIP state machine 119 enters the OPEN-INIT state (Block 614). Otherwise, the LIP state machine 119 interrupts the firmware and sets the STOP bit (Block 628), and the LIP state machine 119 enters the LIHA mode as a slave device (Block 630).

If the received LIP frame is not a LIP primitive, then the LIP state machine checks 119 the value of LP_TOV and determines if the received frame is a CLS frame or is otherwise a bad initialization frame (Block 616). If not, operations proceed to Block 624. If there is a timeout or if a CLS or bad frame is received, then the LIP state machine 119 checks to see if it should restart on any of those occurrences (Block 618). If so, the LIP state machine 119 sends a LIP primitive (Block 620) and enters the IDLE state (Block 622).

In Block 624, the LIP state machine 119 checks to see if a LIPA frame has been received. If not, the LIP state machine 119 returns to the LIHA state (Block 602). However, if a LIPA frame has been received, the LIP state machine 119 checks to see if the hardware assist flag is on, indicating that the process should be handled by the state machine 119 (Block 626). If not, the LIP state machine 119 interrupts the firmware and sets the STOP bit (Block 628).

If the hardware assist flag is on, then the LIP state machine 119 processes the LIPA frame according to the information in the LIPA frame and the stored state information (Blocks 632, 634, 636, 638 and 640). After processing the LIPA frame, the LIP state machine 119 enters the LISA state (Block 642).

The proposed hardware implementation of LIP processing may have a number of advantages. For example, in some embodiments, no additional storage may be used for LIP frames. That is, an implementation according to some embodiments may not require that the generated frames be stored or created by firmware. Frames originated by the port 110 may be created on-the-fly by hardware using state variables stored in the control registers 117.

Furthermore, received frames may be stored in existing TX buffers. Thus, additional storage may not be required for processing the received frames.

Also, in some embodiments, the inter-event delays may be programmable to potentially permit better interoperability with other devices on the loop. This may allow the device 110 to mimic the characteristics of other devices during the LIP process, and may make the device 110 more compatible with different devices.

A system according to some embodiments may use few additional state machines beyond those normally used in a Fibre Channel port. State machines exist to process received frames and manage transition of frames during normal operation. The additional processing of RX/TX frames during the LIP process may be performed using a few additional states that may be added at low cost to the existing state machines.

Finally, some risks associated with a hardware-based approach may be reduced or minimized by the use of control bits that allow a flexible firmware-driven approach, if desired. A set of registers loaded by the device controller 150 at start up allow programming the LIP state machine 119 to make the LIP implementation range from fully firmware driven to fully automated with a minimum of additional memory and logic. This may permit dealing with extreme cases, such as implementation errors and exceptions, by having them handled by the device controller 150 instead of the LIP state machine 119. While this approach may demand attention from the device controller 150, it may not use as much of the controller's resources as having the device controller 150 carry out the entire LIP process.

While embodiments have been described in connection with a Fibre Channel loop port, some embodiments may be applicable to controlling initialization procedures for other types of communication ports, such as SCSI ports.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A device comprising a loop port controlled by a loop initialization procedure in response to control flags.

2. The device of claim 1, wherein the loop port comprises a fibre channel loop port.

3. The device of claim 1, further comprising a programmable controller, wherein the loop port comprises a port control circuit that controls the loop initialization procedure in response to the control flags, and wherein the control flags are set by the programmable controller.

4. The device of claim 3, wherein the control flags include control bits that indicate whether or not the loop port will participate in one or more loop initialization steps, and the port control circuit controls the loop initialization procedure in response to the control bits.

5. The device of claim 3, wherein the control flags include control bits that indicate whether the port control circuit will restart upon occurrence of a timeout, receipt of a bad initialization frame, or upon the receipt of a CLS primitive, and the port control circuit controls the loop initialization procedure in response to the control bits.

6. The device of claim 3, wherein the control flags include a control bit that indicates whether the port will act as a Loop Initialization Master, and control bits that indicate whether originating and/or processing of an initialization frame should be performed by the port control circuit or by the programmable controller, and the port control circuit controls the loop initialization procedure in response to the control bit(s).

7. The device of claim 3, wherein the control flags include control bits that specify an initialization timeout value, control bits that indicate what the port control circuit should do with improperly formed initialization frames, control bits that specify buffer credit support, and/or control bits that specify whether or not the port supports Fairness in Arbitration, and the port control circuit controls the loop initialization procedure in response to the control bits.

8. The device of claim 3, wherein the port control circuit transfers control of the initialization procedure to the programmable controller upon occurrence of a specified event during the initialization procedure.

9. The device of claim 8, wherein the port control circuit interrupts the programmable controller upon occurrence of the specified event, wherein the port control circuit provides an indication to the programmable controller of the reason for the interrupt.

10. The device of claim 3, further comprising a timer that generates a timer signal in response to a timeout value, wherein the port control circuit delays an initialization event until receipt of the timer signal.

11. The device of claim 10, wherein the delayed initialization event comprises sending a LIFA, LIPA, LIHA, LISA, LIRP or LILP initialization frame and/or sending an ARB primitive and/or a CLS primitive.

12. The device of claim 3, further comprising a receive buffer and a transmit buffer, wherein the port control circuit decodes received initialization frames and loads the received initialization frames into the transmit buffer.

13. The device of claim 12, wherein the port control circuit modifies a received initialization frame of a first frame type to create an initialization frame of a second type.

14. A method comprising:
initializing a loop initialization protocol (LIP) hardware state machine;
controlling LIP operations with the LIP hardware state machine;
determining if control of the loop initialization operations should be transferred to a programmable controller in response to a predetermined loop initialization event; and
if so, transferring control of the loop initialization operations to the programmable controller.

15. The method of claim 14, wherein transferring control of the loop initialization operations to the programmable controller comprises interrupting the programmable controller to request that the programmable controller process the predetermined loop initialization event.

16. The method of claim 14, wherein initializing a control register with a flag bit indicative of a protocol for handling the predetermined initialization event, and wherein determining if control of the loop initialization operations should be transferred to a programmable controller in response to the predetermined loop initialization event comprises testing the flag bit in response to occurrence of the predetermined loop initialization event.

17. The method of claim 16, wherein the flag bit indicates whether or not the hardware state machine should originate a LISM frame and/or a LIRP frame without firmware intervention.

18. The method of claim 16, wherein the flag bit indicates whether or not the hardware state machine should process a LIFA, LIHA, LILP, LIPA LIRP and/or a LISA frame without firmware intervention.

19. The method of claim 18, further comprising delaying at least one LIP operation for a predetermined delay period.

20. The method of claim 19, wherein delaying a LIP operation comprises delaying sending of a LIP initialization frame for the predetermined delay period.

21. A method comprising:
initializing a loop initialization protocol (LIP) hardware state machine comprising a plurality of states; and
controlling LIP operations with the LIP hardware state machine;
wherein at least one of the states of the LIP hardware state machine can implement LIP operations in both a loop initialization master mode and a non-master mode.

22. The method of claim 21, further comprising:
determining if control of the loop initialization operations should be transferred to a programmable controller in response to a predetermined loop initialization event; and
if so, transferring control of the loop initialization operations to the programmable controller.
